(19) United States
(12) Patent Application Publication
(10) Pub. No.: US 2024/0306204 A1
(43) Pub. Date: Sep. 12, 2024

(54) METHOD FOR PERFORMING DYNAMIC SUPER-BAND OPERATION IN WIRELESS SYSTEM FOR USING OVERLAPPING CHANNELS DYNAMICALLY, AND ASSOCIATED APPARATUS

(71) Applicant: MEDIATEK INC, Hsin-Chu (TW)

(72) Inventor: Cheng-Yi Chang, Hsinchu City (TW)

(73) Assignee: MEDIATEK INC, Hsin-Chu (TW)

(21) Appl. No.: 18/599,165

(22) Filed: Mar. 7, 2024

Related U.S. Application Data
(60) Provisional application No. 63/489,507, filed on Mar. 10, 2023.

(51) Int. Cl. H04W 74/0816; H04W 8/22; H04W 74/08

(52) U.S. Cl. CPC H04W 74/0816; H04W 8/22; H04W 74/0866

(57) ABSTRACT

A method for performing dynamic super-band operation (DSO) in a wireless communication system and associated apparatus are provided, where a plurality of non-access-point stations (non-AP STAs) are wirelessly linking to a first access point (AP) having a maximum clear channel assessment (CCA) bandwidth capability corresponding to a maximum CCA bandwidth, and the non-AP STAs are able to link to the first AP via a plurality of channels within the maximum CCA bandwidth, respectively. The method may include: providing a maximum transceiver bandwidth capability for at least one of the non-AP STAs smaller than the maximum CCA bandwidth capability of the first AP; and dynamically determining a first channel among the plurality of channels for data transmission of the first AP and the at least one of the non-AP STAs, based on channel utilization status of the plurality of channels within the maximum CCA bandwidth.

### CROSS REFERENCE TO RELATED APPLICATIONS

This application claims the benefit of U.S. Provisional Application No. 63/489,507, filed on Mar. 10, 2023. The content of the application is incorporated herein by reference.

### BACKGROUND

The present invention is related to communication control, and more particularly, to a method for performing dynamic super-band operation (DSO) in a wireless communication system, and associated apparatus such as a wireless transceiver device (e.g., an access point (AP) device or a station (STA) device) in the wireless communication system.

According to the related art, a wireless communication system such as a Wi-Fi system may be very crowded in many circumstances, and the performance may be degraded severely in some scenarios such as dense overlapping basic service set (OBSS) or wireless scenarios, especially for the bandwidth efficiency with wider bandwidth configurations. For example, a suggestion of defining a first 320 megahertz (MHz) bandwidth configuration and a second 320 MHz bandwidth configuration may have been proposed to increase the flexibility of 320 MHz bandwidth channel selection. However, the network conditions are often dynamic in real cases. Neither the first 320 MHz bandwidth configuration nor the second 320 MHz bandwidth configuration may work well in dynamic real conditions. Thus, a novel method and associated architecture are needed for solving the problems without introducing any side effect or in a way that is less likely to introduce a side effect.

### SUMMARY

It is an objective of the present invention to provide a method for performing DSO in a wireless communication system, and associated apparatus such as wireless transceiver devices (e.g., one or more AP devices and one or more non-access-point (non-AP) STA devices) in the wireless communication system, in order to solve the above-mentioned problems.

At least one embodiment of the present invention provides a method for performing DSO in a wireless communication system, where a plurality of non-AP STAs may be wirelessly linking to a first AP having a maximum clear channel assessment (CCA) bandwidth capability corresponding to a maximum CCA bandwidth, the non-AP STAs being able to link to the first AP via a plurality of channels within the maximum CCA bandwidth, respectively. The method may comprise: providing a maximum transceiver bandwidth capability for at least one of the non-AP STAs smaller than the maximum CCA bandwidth capability of the first AP; and dynamically determining a first channel among the plurality of channels for data transmission of the first AP and the at least one of the non-AP STAs, based on channel utilization status of the plurality of channels within the maximum CCA bandwidth.

At least one embodiment of the present invention provides a non-AP STA device for performing DSO in a wireless communication system such as that mentioned above, where the non-AP STA device may be one of multiple devices within the wireless communication system. The non-AP STA device may comprise a processing circuit that is arranged to control operations of the non-AP STA device. The non-AP STA device may further comprise at least one communication control circuit that is coupled to the processing circuit and arranged to perform communication control, where the aforementioned at least one communication control circuit is arranged to perform wireless communication operations with at least one other device among the multiple devices within the wireless communication system for the non-AP STA device. For example, the aforementioned at least one other device may comprise a first AP device, and a plurality non-AP STA devices comprising the non-AP STA device may be wirelessly linking to the first AP device having a maximum CCA bandwidth capability corresponding to a maximum CCA bandwidth, wherein the non-AP STA devices are able to link to the first AP device via a plurality of channels within the maximum CCA bandwidth, respectively. In addition, at least one of the non-AP STA devices, comprising the non-AP STA device, may be arranged to provide a maximum transceiver bandwidth capability for the aforementioned at least one of the non-AP STA devices smaller than the maximum CCA bandwidth capability of the AP device. Additionally, the aforementioned at least one of the non-AP STA devices, comprising the non-AP STA device, may be arranged to dynamically determine a first channel among the plurality of channels for data transmission of the first AP device and the aforementioned at least one of the non-AP STA devices, based on channel utilization status of the plurality of channels within the maximum CCA bandwidth.

According to some embodiments, the present invention also provides an AP device for performing DSO in a wireless communication system such as that mentioned above, where the AP device may be one of multiple devices within the wireless communication system. The AP device may comprise a processing circuit that is arranged to control operations of the AP device. The AP device may further comprise at least one communication control circuit that is coupled to the processing circuit and arranged to perform communication control, where the aforementioned at least one communication control circuit is arranged to perform wireless communication operations with at least one other device among the multiple devices within the wireless communication system for the AP device. For example, the aforementioned at least one other device may comprise a plurality of non-AP STA devices, and the plurality of non-AP STA devices may be wirelessly linking to the AP device having a maximum CCA bandwidth capability corresponding to a maximum CCA bandwidth, wherein the non-AP STA devices are able to link to the AP device via a plurality of channels within the maximum CCA bandwidth, respectively. In addition, at least one of the non-AP STA devices may be arranged to provide a maximum transceiver bandwidth capability for the aforementioned at least one of the non-AP STA devices smaller than the maximum CCA bandwidth capability of the AP device. More particularly, the aforementioned at least one of the non-AP STA devices may be arranged to dynamically determine a first channel among the plurality of channels for data transmission of the AP device and the aforementioned at least one of the non-AP STA devices, based on channel utilization status of the plurality of channels within the maximum CCA bandwidth. Additionally, the aforementioned at least one of the non-AP STA devices may be arranged to carry at least one DSO capability indication in at least one physical layer (PHY) protocol data unit (PPDU) from the aforementioned at least one of the non-AP STA devices to the AP device, in order to notify the AP device of the determination regarding the first channel, and the AP device may be arranged to dynamically use the first channel during the data transmission of the AP device and the aforementioned at least one of the non-AP STA devices.

It is an advantage of the present invention that, through proper design, the present invention method, as well as the associated apparatus such as the wireless transceiver devices (e.g., the one or more AP devices and the one or more non-AP STA devices) in the wireless communication system, can access the spectrum dynamically for system performance enhancement in dense wireless scenarios, in order to dynamically utilize multiple channels (e.g., multiple overlapping channels that overlap each other) such as that of the first 320 MHz bandwidth configuration and the second 320 MHz bandwidth configuration. In addition, the present invention method and apparatus can solve the related art problems without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a wireless communication system according to an embodiment of the present invention.

FIG. 2 illustrates, in the right half part thereof, an expanded CCA bandwidth control scheme of a method for performing DSO in a wireless communication system according to an embodiment of the present invention, where a limited CCA bandwidth control scheme may be illustrated in the left half part of FIG. 2 for better comprehension.

FIG. 3 illustrates, in the right half part thereof, some implementation details of the expanded CCA bandwidth control scheme shown in FIG. 2 according to an embodiment of the present invention, where some implementation details of the limited CCA bandwidth control scheme shown in FIG. 2 may be illustrated in the left half part of FIG. 3 for better comprehension.

FIG. 4 illustrates, in the sub-diagrams (a), (b) and (c) thereof, a same primary channel control scheme, a different primary channel control scheme and a non-contiguous channel control scheme of the method according to an embodiment of the present invention.

FIG. 5 illustrates a channel-overlapped enhanced multi-link single radio (EMLSR) control scheme of the method according to an embodiment of the present invention.

FIG. 6 illustrates a first shared primary channel control scheme of the method according to an embodiment of the present invention.

FIG. 7 illustrates a second shared primary channel control scheme of the method according to an embodiment of the present invention.

FIG. 8 illustrates an inter-PPDU handshaking control scheme of the method according to an embodiment of the present invention.

FIG. 9 illustrates a Service field format involved with the inter-PPDU handshaking control scheme shown in FIG. 8 according to an embodiment of the present invention.

FIG. 10 illustrates an intra-PPDU signaling control scheme of the method according to an embodiment of the present invention.

FIG. 11 illustrates a first cooperative super-band operation (CSO) control scheme of the method according to an embodiment of the present invention.

FIG. 12 illustrates a second CSO control scheme of the method according to an embodiment of the present invention.

FIG. 13 illustrates a third CSO control scheme of the method according to an embodiment of the present invention.

FIG. 14 illustrates a Trigger frame format, a Common Info field format and an UL Spatial Reuse subfield format involved with a CCA information control scheme of the method according to an embodiment of the present invention.

FIG. 15 illustrates a plurality of transceiver bandwidth (BW) designs involved with a dynamic spectrum access (DSA) control scheme of the method according to an embodiment of the present invention.

FIG. 16 illustrates a working flow of the method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

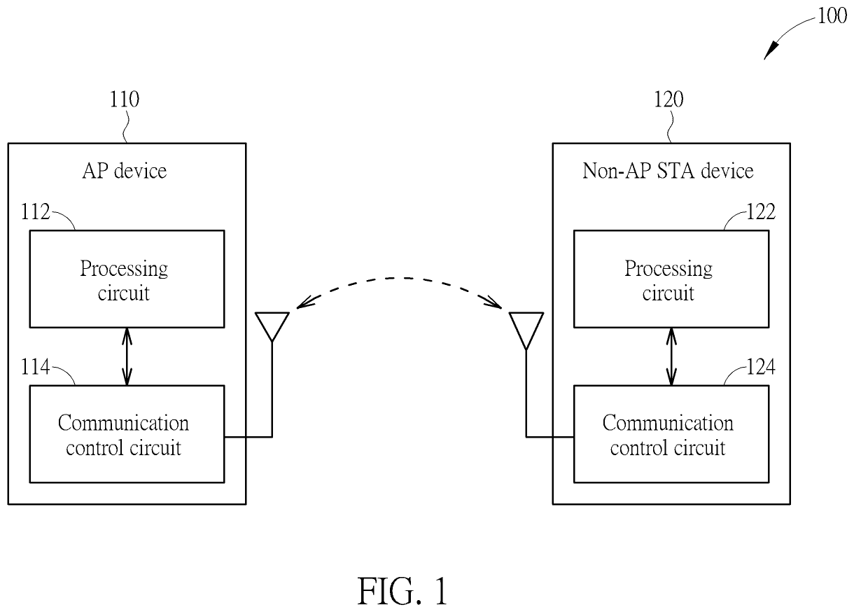

FIG. 1 is a diagram of a wireless communication system 100 according to an embodiment of the present invention. For better comprehension, the wireless communication system 100, as well as any wireless transceiver device #n among multiple wireless transceiver devices #1, . . . and #N therein, may be compatible or backward-compatible to one or more versions of the Institute of Electrical and Electronics Engineers (IEEE) 802.11 standards, but the present invention is not limited thereto. Regarding the multiple wireless transceiver devices #1, . . . and #N within the wireless communication system 100, a wireless transceiver device among them may be implemented as an AP device 110, and another transceiver device among them may be implemented as a non-AP STA device 120, but the present invention is not limited thereto. For example, two or more wireless transceiver devices among the multiple wireless transceiver devices #1, . . . and #N may be implemented as multiple AP devices {110}. For another example, two or more wireless transceiver devices among the multiple wireless transceiver devices #1, . . . and #N may be implemented as multiple non-AP STA devices {120}. In some examples, two or more wireless transceiver devices among the multiple wireless transceiver devices #1, . . . and #N may be implemented as multiple AP devices {110}, and two or more other wireless transceiver devices among the multiple wireless transceiver devices #1, . . . and #N may be implemented as multiple non-AP STA devices {120}.

As shown in FIG. 1, the AP device 110 may comprise a processing circuit 112, at least one communication control circuit (e.g., one or more communication control circuits), which may be collectively referred to as the communication control circuit 114, and at least one antenna (e.g., one or more antennas) of the communication control circuit 114, and the non-AP STA device 120 may comprise a processing circuit 122, at least one communication control circuit (e.g., one or more communication control circuits), which may be collectively referred to as the communication control circuit 124, and at least one antenna (e.g., one or more antennas) of the communication control circuit 124. In the architecture shown in FIG. 1, the processing circuit 112 can be arranged to control operations of the AP device 110, and the communication control circuit 114 can be arranged to perform communication control, and more particularly, perform wireless communication operations with the network (or at least one other device therein such as the non-AP STA device 120) for the AP device 110. In addition, the processing circuit 122 can be arranged to control operations of the non-AP STA device 120, and the communication control circuit 124 can be arranged to perform communication control, and more particularly, perform wireless communication operations with the network (or at least one other device therein such as the AP device 110) for the non-AP STA device 120.

According to some embodiments, the processing circuit 112 can be implemented by way of at least one processor/microprocessor, at least one random access memory (RAM), at least one bus, etc., and the communication control circuit 114 can be implemented by way of at least one wireless network control circuit and at least one wired network control circuit, but the present invention is not limited thereto. Examples of the AP device 110 may include, but are not limited to: a Wi-Fi router. In addition, the processing circuit 122 can be implemented by way of at least one processor/microprocessor, at least one RAM, at least one bus, etc., and the communication control circuit 124 can be implemented by way of at least one wireless network control circuit, but the present invention is not limited thereto. Examples of the non-AP STA device 120 may include, but are not limited to: a multifunctional mobile phone, a laptop computer, an all-in-one computer and a wearable device.

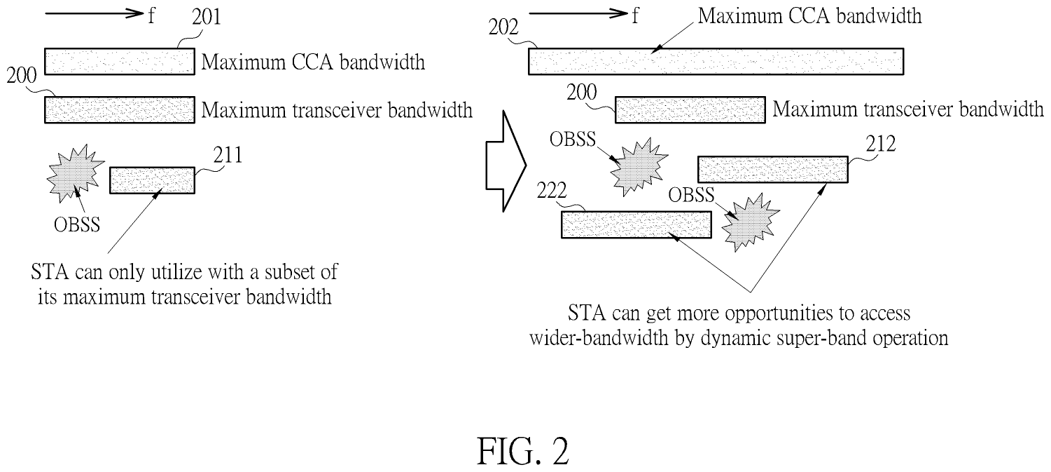

FIG. 2 illustrates, in the right half part thereof, an expanded CCA bandwidth control scheme of a method for performing DSO in a wireless communication system such as the wireless communication system 100 shown in FIG. 1 according to an embodiment of the present invention, where a limited CCA bandwidth control scheme may be illustrated in the left half part of FIG. 2 for better comprehension. The method can be applied to the wireless transceiver device #n such as the AP device 110 and another wireless transceiver device #n′ such as the non-AP STA device 120 for performing DSO in the wireless communication system 100, and the associated operations of the wireless communication system 100 operating according to the method may comprise:
(1) the wireless communication system 100 may utilize the non-AP STA device 120 (or the communication control circuit 124 therein) to provide a maximum CCA bandwidth of the non-AP STA device 120 that is greater than a maximum transceiver bandwidth of the non-AP STA device 120, for switching among multiple non-20 MHz channels (e.g., multiple 320 MHz bandwidth (BW320) channels) consist of multiple 20 MHz channels (or 20 MHz bandwidth (BW20) channels) corresponding to the maximum CCA bandwidth when at least one clear channel is detected, where any non-20 MHz channel (e.g., any BW320 channel) among the multiple non-20 MHz channels (e.g., the multiple BW320 channels) may comprise a set of 20 MHz channels (e.g., a set of BW20 channels) corresponding to the maximum transceiver bandwidth;
(2) the wireless communication system 100 may utilize the non-AP STA device 120 (or the communication control circuit 124 therein) to dynamically determine at least a first non-20 MHz channel among the multiple non-20 MHz channels (e.g., the multiple BW320 channels) for performing data transmission between the AP device 110 and the non-AP STA device 120, in order to prevent using at least one first OBSS-occupied channel of at least one OBSS during the data transmission between the AP device 110 and the non-AP STA device 120;
(3) the wireless communication system 100 may utilize the non-AP STA device 120 (or the communication control circuit 124 therein) to carry at least one DSO capability indication in at least one PPDU such as at least one first PPDU from the non-AP STA device 120 to the AP device 110, in order to notify the AP device 110 of the determination regarding at least the first non-20 MHz channel; and
(4) the wireless communication system 100 may utilize the AP device 110 (or the communication control circuit 114 therein) to dynamically use at least the first non-20 MHz channel during the data transmission between the AP device 110 and the non-AP STA device 120, in order to enhance the overall performance (e.g., spectrum efficiency and system efficiency) of the wireless communication system 100;
where at least one portion of non-20 MHz channels among the multiple non-20 MHz channels (e.g., the multiple BW320 channels), such as a portion of non-20 MHz channels or all non-20 MHz channels among the multiple non-20 MHz channels, may overlap each other, and the first non-20 MHz channel may be a non-20 MHz channel among the aforementioned at least one portion of non-20 MHz channels, but the present invention is not limited thereto. For example, the aforementioned at least one portion of non-20 MHz channels may comprise a first 320 MHz bandwidth channel (or “the BW320-1 channel”) and a second 320 MHz bandwidth channel (or “the BW320-2 channel”), and the 320 MHz bandwidths of the BW320-1 channel and the BW320-2 channel may be referred to as the BW320-1 and the BW320-2, respectively. In addition, the non-AP STA device 120 (or the communication control circuit 124) may dynamically determine a second non-20 MHz channel among the multiple non-20 MHz channels (e.g., the multiple BW320 channels) for performing the data transmission between the AP device 110 and the non-AP STA device 120, in order to prevent using at least one second OBSS-occupied channel of the aforementioned at least one OBSS during the data transmission between the AP device 110 and the non-AP STA device 120, and may carry at least one second DSO capability indication in at least one other PPDU such as at least one second PPDU from the non-AP STA device 120 to the AP device 110, in order to notify the AP device 110 of the determination regarding the second non-20 MHz channel, and the AP device 110 (or the communication control circuit 114) may dynamically use the second non-20 MHz channel during the data transmission between the AP device 110 and the non-AP STA device 120.

For better comprehension, assume that one or more functions of the wireless communication system 100 may be temporarily disabled to allow the AP device 110 and the non-AP STA device 120 to operate according to the limited CCA bandwidth control scheme shown in the left half part of FIG. 2, and the horizontal axis may represent the frequency f, but the present invention is not limited thereto. Based on the limited CCA bandwidth control scheme, the original maximum CCA bandwidth 201 of the non-AP STA device 120 is a limited CCA bandwidth that is equal to the maximum transceiver bandwidth 200 of the non-AP STA device 120, and will not be highlighted or referred to since all existing solutions may merely focus on the maximum transceiver bandwidth 200 rather than the maximum CCA bandwidth 201. When a partial bandwidth of the maximum transceiver bandwidth 200 is occupied by an OBSS, the non-AP STA device 120 that is operating according to the limited CCA bandwidth control scheme can only utilize the wireless media with a subset 211 of its maximum transceiver bandwidth 200, for example, by performing a puncturing operation corresponding to the OBSS-occupied partial bandwidth to obtain the remaining bandwidth as the subset 211 of the maximum transceiver bandwidth 200.

As shown in the right half part of FIG. 2, the wireless communication system 100 (or the AP device 110 and the non-AP STA device 120 therein) may operate according to the expanded CCA bandwidth control scheme to achieve a better overall performance, and the new maximum CCA bandwidth 202 of the non-AP STA device 120 is an expanded CCA bandwidth that is greater than the maximum transceiver bandwidth 200 of the non-AP STA device 120. For example, the associated operations may comprise:
(1) the non-AP STA device 120 may determine the first non-20 MHz channel to exclude the aforementioned at least one first OBSS-occupied channel, for using the first non-20 MHz channel corresponding to the maximum transceiver bandwidth 200 while preventing the interference from a first OBSS among the aforementioned at least one OBSS, where the first non-20 MHz channel may also correspond to a subset 212 of the new maximum CCA bandwidth 202, and the subset 212 may have the same width (or size) as that of the maximum transceiver bandwidth 200; and
(2) the non-AP STA device 120 may determine the second non-20 MHz channel to exclude the aforementioned at least one second OBSS-occupied channel, for using the second non-20 MHz channel corresponding to the maximum transceiver bandwidth 200 while preventing the interference from a second OBSS among the at least one OBSS, where the second non-20 MHz channel may also correspond to a subset 222 of the new maximum CCA bandwidth 202, and the subset 222 may have the same width (or size) as that of the maximum transceiver bandwidth 200; but the present invention is not limited thereto. For another example, the second OBSS may be equal to the first OBSS, and the non-AP STA device 120 may determine the second non-20 MHz channel to exclude the aforementioned at least one second OBSS-occupied channel, for using the second non-20 MHz channel corresponding to the maximum transceiver bandwidth 200 while preventing the interference from the first OBSS. No matter whether the second OBSS is equal to the first OBSS, the non-AP STA device 120 can get more opportunities to access wider-bandwidth by performing the DSO.

Based on the expanded CCA bandwidth control scheme, the non-AP STA device 120 can perform dynamic channel access by decoupling the CCA bandwidth and the transceiver bandwidth. Therefore, the wireless communication system 100 (or the AP device 110 and the non-AP STA device 120 therein) operating according to the method can effectively increase the bandwidth efficiency in OBSS scenarios by hopping within the CCA-detectable spectrum. For example, the aforementioned any wireless transceiver device #n such as the AP device 110 may be implemented as an AP multi-link device (MLD) having multiple APs affiliated with the AP MLD, with the multiple APs being capable of co-working closely to utilize multiple wireless media efficiently and to increase transmission/reception diversity, and the other wireless transceiver device #n′ such as the non-AP STA device 120 may be implemented as a non-AP STA MLD. More particularly, the communication control circuit 114 may comprise multiple communication control circuits (e.g., two or more communication control circuits acting as two or more APs) for communicating with the non-AP STA device 120 via multiple links (e.g., two or more links) respectively corresponding to multiple predetermined radio frequency (RF) bands (e.g., two or more predetermined RF bands) such as the 2.4 gigahertz (GHz) band, the 5 GHz band and the 6 GHz band, and the communication control circuit 124 may comprise multiple communication control circuits (e.g., two or more communication control circuits acting as two or more STAs) for communicating with the AP device 110 via the multiple links (e.g., the two or more links) respectively corresponding to the multiple predetermined RF bands (e.g., the two or more predetermined RF bands) such as the 2.4 GHz band, the 5 GHz band and the 6 GHz band. Regarding multi-link operation (MLO) control, the wireless communication system 100 (or the AP device 110 and the non-AP STA device 120 therein) can operate according to the method to enhance the spectrum efficiency, the system efficiency, etc. of the wireless communication system 100.

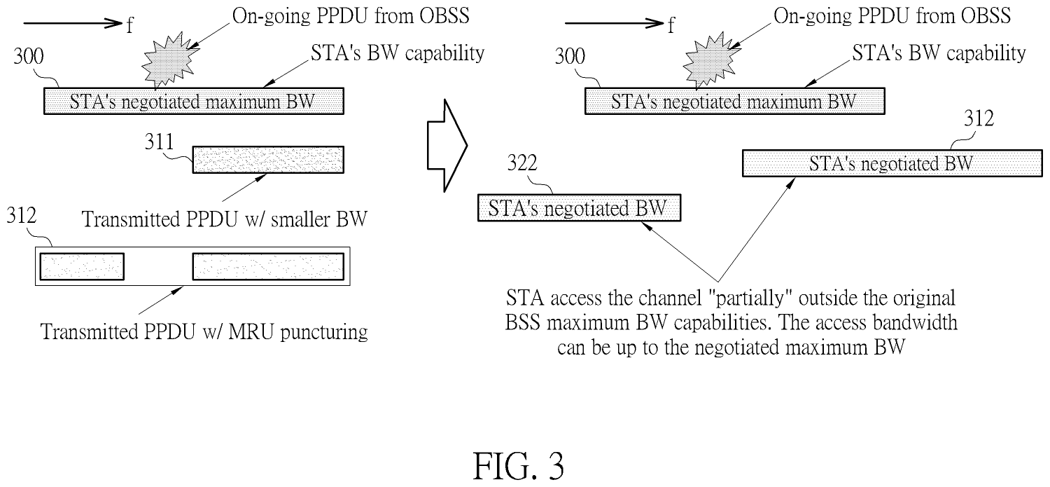

FIG. 3 illustrates, in the right half part thereof, some implementation details of the expanded CCA bandwidth control scheme shown in FIG. 2 according to an embodiment of the present invention, where some implementation details of the limited CCA bandwidth control scheme shown in FIG. 2 may be illustrated in the left half part of FIG. 3 for better comprehension. Assuming that one or more functions of the wireless communication system 100 may be temporarily disabled to allow the AP device 110 and the non-AP STA device 120 to operate according to the limited CCA bandwidth control scheme as shown in the left half part of FIG. 3, but the present invention is not limited thereto. Based on the limited CCA bandwidth control scheme, when a partial bandwidth of the negotiated maximum bandwidth (BW) 300 of the non-AP STA device 120 is occupied by an on-going PPDU from an OBSS, the non-AP STA device 120 that is operating according to the limited CCA bandwidth control scheme may only utilize a subset 311 of the negotiated maximum bandwidth 300 for the transmitted PPDU with a smaller bandwidth, or utilize multiple subsets 312 of the negotiated maximum bandwidth 300 for the transmitted PPDU with multiple resource units (MRUs) puncturing (labeled “MRU puncturing” for brevity). Thus, the non-AP STA device 120 operating according to the limited CCA bandwidth control scheme may shrink its bandwidth of the transmitted PPDU or perform MRU puncturing on the transmitted PPDU to access the channel. However, the media access efficiency is still degraded due to the fact that a portion of the bandwidth cannot be available.

As shown in the right half part of FIG. 3, the wireless communication system 100 (or the AP device 110 and the non-AP STA device 120) may operate according to the expanded CCA bandwidth control scheme to achieve the better overall performance. For example, at a first time point of determining the first non-20 MHz channel for performing the data transmission between the AP device 110 and the non-AP STA device 120, the aforementioned at least one OBSS may have occupied at least one portion of the negotiated maximum bandwidth 300 of the non-AP STA device 120, and the non-AP STA device 120 may determine the first non-20 MHz channel to be partially outside the negotiated maximum bandwidth 300, in a first negotiated bandwidth 312 of the non-AP STA device 120, where a first bandwidth of the first non-20 MHz channel may be equal to the negotiated maximum bandwidth 300; and at a second time point of determining another non-20 MHz channel for performing the data transmission between the AP device 110 and the non-AP STA device 120, the aforementioned at least one OBSS may have occupied at least one other portion of the negotiated maximum bandwidth 300 of the non-AP STA device 120, and the non-AP STA device 120 may determine the other non-20 MHz channel to be partially outside the negotiated maximum bandwidth 300, in a second negotiated bandwidth 322 of the non-AP STA device 120, where a second bandwidth of the other non-20 MHz channel may be less than the negotiated maximum bandwidth 300. In addition, the negotiated maximum bandwidth 300 may be less than or equal to the maximum transceiver bandwidth 200 shown in FIG. 2. For example, the negotiated maximum bandwidth 300 may reach the maximum transceiver bandwidth 200, and may be regarded as the bandwidth capability of the non-AP STA device 120 but the present invention is not limited thereto.

Based on the expanded CCA bandwidth control scheme, by dynamically determining at least the first non-20 MHz channel for performing the data transmission between the AP device 110 and the non-AP STA device 120, the data transmission can be performed without degradation of media access efficiency. As shown in FIG. 3, the non-AP STA device 120 can access the channel “partially” outside the original BSS maximum BW capabilities, and the access bandwidth can be up to the negotiated maximum bandwidth 300.

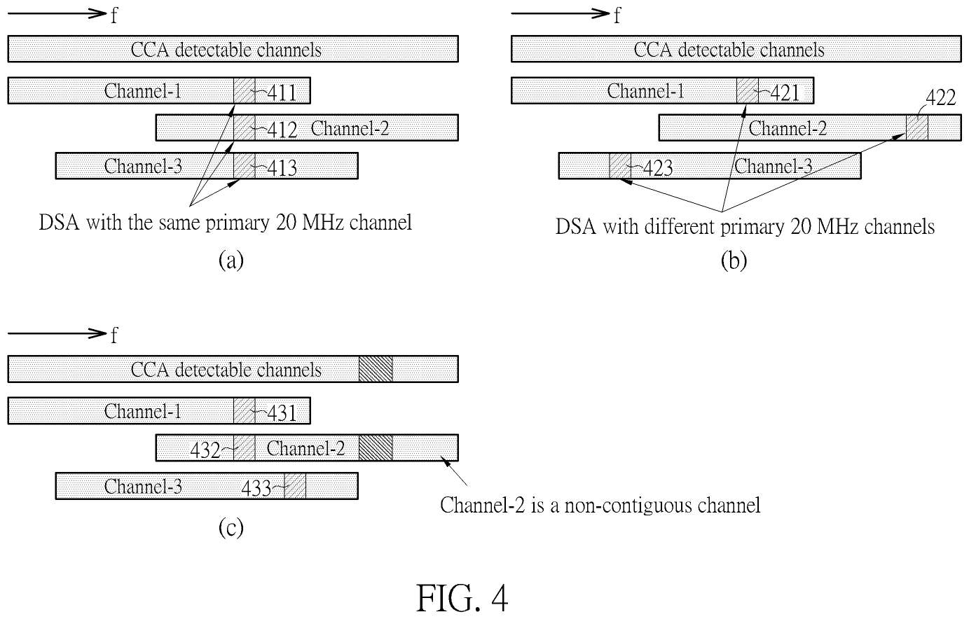

FIG. 4 illustrates, in the sub-diagrams (a), (b) and (c) thereof, a same primary channel control scheme, a different primary channel control scheme and a non-contiguous channel control scheme of the method according to an embodiment of the present invention. The multiple 20 MHz channels (e.g., the multiple 20 MHz bandwidth (BW20) channels) corresponding to the maximum CCA bandwidth 202 may be regarded as CCA detectable channels. As shown in the sub-diagram (a), the first non-20 MHz channel such as the non-20 MHz channel Channel-1 may comprise a set of first sub-channels (e.g., a set of 20 MHz bandwidth (BW20) channels) corresponding to the maximum transceiver bandwidth 200, the second non-20 MHz channel such as the non-20 MHz channel Channel-2 may comprise a set of second sub-channels (e.g., another set of BW20 channels) corresponding to the maximum transceiver bandwidth 200, and a third non-20 MHz channel among the multiple non-20 MHz channels that is determined for performing the data transmission between the AP device 110 and the non-AP STA device 120 may comprise a set of third sub-channels (e.g., yet another set of BW20 channels) corresponding to the maximum transceiver bandwidth 200. In addition, a first primary channel 411 in the set of first sub-channels of the non-20 MHz channel Channel-1, a second primary channel 412 in the set of second sub-channels of the non-20 MHz channel Channel-2 and a third primary channel 413 in the set of third sub-channels of the non-20 MHz channel Channel-3 may be equal to each other, and the non-AP STA device 120 may perform DSA with the same primary channel such as the same primary 20 MHz (or BW20) channel, but the present invention is not limited thereto. As shown in the sub-diagram (b), a first primary channel 421 in the set of first sub-channels of the non-20 MHz channel Channel-1, a second primary channel 422 in the set of second sub-channels of the non-20 MHz channel Channel-2 and a third primary channel 423 in the set of third sub-channels of the non-20 MHz channel Channel-3 may be different from each other, and the non-AP STA device 120 may perform DSA with different primary 20 MHz (or BW20) channels. As shown in the sub-diagram (c), a first primary channel 431 in the set of first sub-channels of the non-20 MHz channel Channel-1 and a second primary channel 432 in the set of second sub-channels of the non-20 MHz channel Channel-2 may be equal to each other, and may be different from a third primary channel 433 in the set of third sub-channels of the non-20 MHz channel Channel-3, and the non-AP STA device 120 may configure the non-20 MHz channel Channel-2 to be a non-contiguous channel.

The non-AP STA device 120 operating according to the method may switch among overlapping channels to perform overlapping channels access, for example, the channel access for Channel No. 31 (or the BW320-1 channel) and Channel No. 63 (or the BW320-2 channel), but the present invention is not limited thereto. The non-AP STA device 120 operating according to the method may switch among various channels such as overlapping channels, non-overlapping channels or non-contiguous channels, in order to perform overlapping channels access, non-overlapping channels access or non-contiguous channels access. For example, it can be classified as co-primary back-off channel as shown in the sub-diagram (a) or different-primary back-off channels as shown in the sub-diagrams (b) and (c). While the back-off is done, the non-AP STA device 120 will select the available spectrum dynamically. The non-AP STA device 120 may carry the capability information in the capabilities fields for the co-primary channel DSO and the different-primary back-off channel DSO.

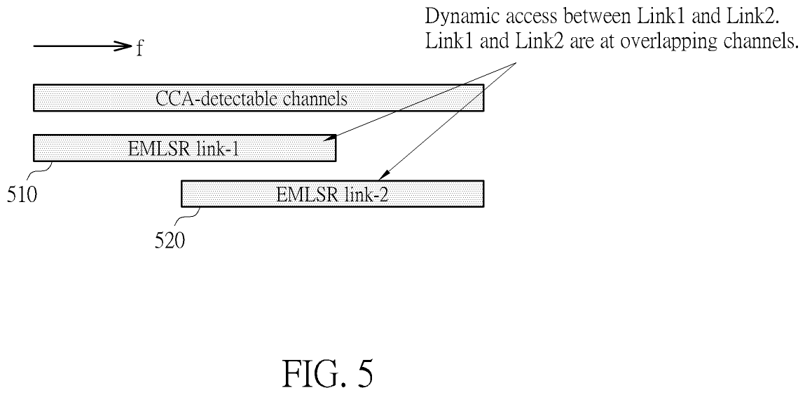

FIG. 5 illustrates a channel-overlapped EMLSR control scheme of the method according to an embodiment of the present invention. The multiple 20 MHz channels (e.g., the multiple BW20 channels) corresponding to the maximum CCA bandwidth 202 may be regarded as CCA-detectable channels. For example, the AP device 110 may be implemented as the AP MLD, and the non-AP STA device 120 may be implemented as the non-AP STA MLD. In addition, at least the first non-20 MHz channel and the second non-20 MHz channel may be configured as a set of channels for MLO, and the data transmission between the AP device 110 and the non-AP STA device 120 may comprise dynamically accessing between a first EMLSR link Link1 (or “the EMLSR link-1”) at the first non-20 MHz channel such as the non-20 MHz channel 510 and a second EMLSR link Link2 (or “the EMLSR link-2”) at the second non-20 MHz channel such as the non-20 MHz channel 520. As shown in FIG. 5, these EMLSR links Link1 and Link2 may be at overlapping channels. More particularly, a capability field in an enhanced multi-link (EML) element may be arranged to specify that a first bandwidth used by the first EMLSR link Link1 and a second bandwidth used by the second EMLSR link Link2 are partially overlapping bandwidths of each other, where the capability field may be arranged to carry a flag and at least one overlapping frequency among the first bandwidth used by the first EMLSR link Link1 and the second bandwidth used by the second EMLSR link Link2.

Based on the channel-overlapped EMLSR control scheme, the wireless communication system 100 (or the AP device 110 and the non-AP STA device 120 therein) may perform dynamic access between link1 and link2. Link1 and link2 are at overlapping channels, where two or more back-off channels (e.g., the non-20 MHz channels 510 and 520) in the partially overlapped channels may be involved with the dynamic access.

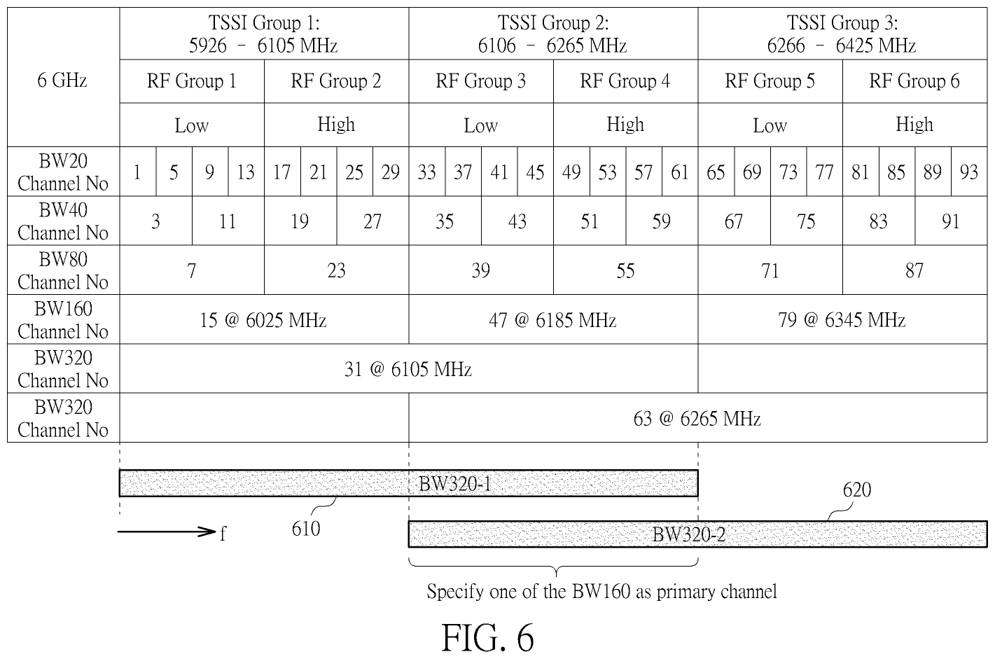

FIG. 6 illustrates a first shared primary channel control scheme of the method according to an embodiment of the present invention. As shown in FIG. 6, there may be a series of 20 MHz bandwidth (BW20) channels having predetermined channel numbers such as Channel No. {{1, 5, 9, 13}, . . . , {81, 85, 89, 93}}, a series of 40 MHz bandwidth (BW40) channels having predetermined channel numbers such as Channel No. {{3, 11}, . . . , {83, 91} }, a series of 80 MHz bandwidth (BW80) channels having predetermined channel numbers such as Channel No. {7, 23, . . . , 87}, and a series of 160 MHz bandwidth (BW160) channels having predetermined channel numbers such as Channel No. {15, 47, 79}, for example, centered at (or “@”) {6025, 6185, 6345} MHz, respectively, as well as the 320 MHz bandwidth (BW320) channels having predetermined channel numbers such as Channel No. {31, 63}, for example, centered at {6105, 6265} MHz, respectively, but the present invention is not limited thereto. The first non-20 MHz channel such as the BW320-1 channel 610 and the second non-20 MHz channel such as the BW320-2 channel 620 may overlap each other, and the first non-20 MHz channel and the second non-20 MHz channel may be configured as channels in a first predetermined RF band (e.g., the 6 GHz band) among the multiple predetermined RF bands. Additionally, when there is a need, the wireless communication system 100 (or the AP device 110 and/or the non-AP STA device 120 therein) may specify one of the BW160 channel as a primary channel, and perform dual BW320 access with seamless dynamic channel selection in interference environments.

Based on the first shared primary channel control scheme, as the BW320-1 and BW320-2 channels may have been proposed with overlapping channels in the 6 GHz band, it is workable to support the overlapping BW320-1 and BW320-2 channels concurrently for system performance optimization according to the method. According to some embodiments, the overlapping channels may vary, and similar control schemes of the method can also be applied to the wireless communication system 100 (or the AP device 110 and the non-AP STA device 120) for the other RF bands (e.g., the 2.4 GHz band the 5 GHz band) among the multiple predetermined RF bands. For example, overlapping BW160 channels can be defined in the 5 GHz band. For another example, overlapping BW40 channels can be defined in the 2.4 GHz band.

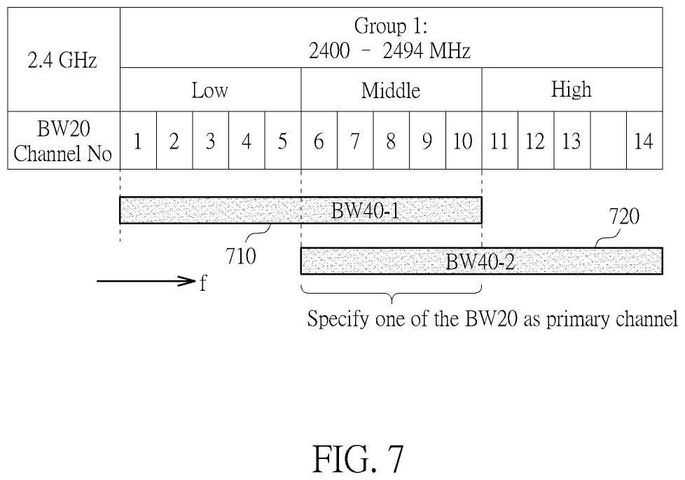

FIG. 7 illustrates a second shared primary channel control scheme of the method according to an embodiment of the present invention. The first non-20 MHz channel such as a first 40 MHz bandwidth channel (or “the BW40-1 channel”) 710 and the second non-20 MHz channel such as a second 40 MHz bandwidth channel (or “the BW40-2 channel”) 720 may overlap each other and may be configured as channels in a certain predetermined RF band (e.g., the 2.4 GHz band) among the multiple predetermined RF bands, and the 40 MHz bandwidths of the BW40-1 channel and the BW40-2 channel may be referred to as the BW40-1 and the BW40-2, respectively. Additionally, when there is a need, the wireless communication system 100 (or the AP device 110 and/or the non-AP STA device 120 therein) may specify one of the BW20 channel as a primary channel, and perform dual BW40 access with seamless dynamic channel selection in interference environments.

According to some embodiments, the AP device 110 may support dual BW320 access, where some non-AP STA devices {120} may be connected to the AP device 110 via the BW320-1 channel and/or the same non-AP STA device 120 may be connected to the AP device 110 via the BW320-2 channel. Regarding the bandwidth (BW) overlapping MLO, the AP device 110 and the non-AP STA device 120 can be implemented as the AP MLD and the non-AP STA MLD to support dual BW320 access, and can select the larger one to transmit, and even occupy the secondary BW160 channel for dealing with the adjacent channel interference (ACI). As the wireless communication system 100 operating according to the method may be arranged to decouple the CCA bandwidth such as the maximum CCA bandwidth 202 and the transceiver (TRX) bandwidth such as the maximum transceiver bandwidth 200, the AP device 110 can perform multi-user transmission, trigger-based (TB), for two basic service sets (BSSs) in the same PPDU, for example, in the primary BW160 channel among in the whole 480 MHz bandwidth (BW480). According to some embodiments, the wireless communication system 100 (or the AP device 110 and/or the non-AP STA device 120 therein) may operate according to a dual BW320 control scheme of the method to perform alternative BW320 selection. Regarding dual BW320 versus BW320+BW160 (or “the BW320+BW160”) in contiguous BW480, the BW320+BW160 STR (or Simultaneous Transmit and Receive) AP may have better system performance such as better throughput, latency, etc., for example, with larger bandwidth aggregation BW480, more channel access opportunities (when using two primary channel) and substantially the same transceiver design complexity (up-to BW320), and may require a very shaper filter and require two MAC processing circuits and two PHY processing circuits as well as a larger chip area and associated cost. Additionally, the BW320 STA connected to the BW160 AP may have less instantaneous throughput than the BW320 STA connected to the BW320 AP.

According to some embodiments, the non-AP STA device 120 may be arranged to carry at least one DSO capability indication in a first communication frame from the non-AP STA device 120 to the AP device 110, for specifying at least one DSO capability of the non-AP STA device 120 and/or indicating that the non-AP STA device 120 supports the DSO, in order to dynamically switch among the multiple non-20 MHz channels. For example, in a situation where the non-AP STA device 120 supports the DSO, the non-AP STA device 120 may use the aforementioned at least one DSO capability indication to specify one or a combination of at least one operating bandwidth and at least one operating channel regarding the DSO, such as dynamic super-band operating bandwidth and/or dynamic super-band operating channels. In addition, the non-AP STA device 120 and the AP device 110 may communicate with each other using at least one DSO protocol, and more particularly, may perform handshaking in multiple ways (e.g., inter-PPDU handshaking and intra-PPDU signaling) for using the targeted access channel(s).

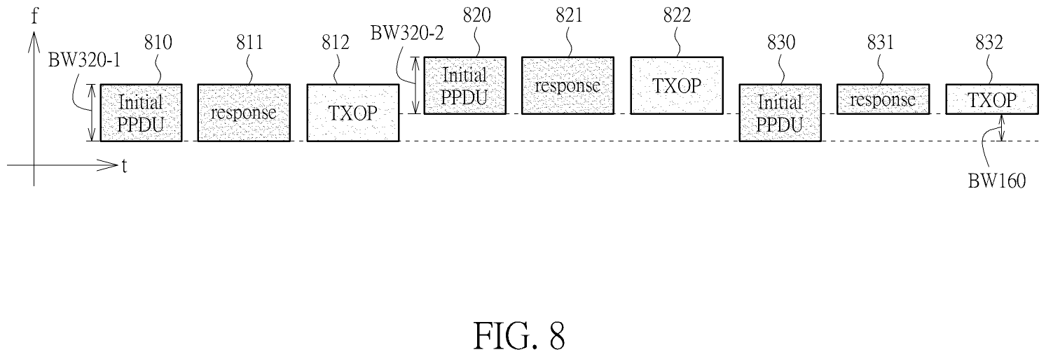

FIG. 8 illustrates an inter-PPDU handshaking control scheme of the method according to an embodiment of the present invention. The horizontal axis may represent the time t, and the vertical axis may represent the frequency f. The non-AP STA device 120 may carry at least one DSO capability indication in an initial PPDU from the non-AP STA device 120 to the AP device 110, for indicating at least one DSO capability of the non-AP STA device 120, and one or more access channels may be configured with inter-PPDU handshaking, where the inter-PPDU handshaking may comprise negotiating by using the initial PPDU and a response of the initial PPDU that is sent from the AP device 110, and the first non-20 MHz channel may be implemented as the one or more access channels.

Based on the inter-PPDU handshaking control scheme, the non-AP STA device 120 and the AP device 110 can negotiate the access channel by using the initial PPDU and the response of the initial PPDU. For example, the initial PPDU can be implemented by a per-20 MHz duplicated PPDU which is arranged to specify the DSO-related information such as the aforementioned at least one DSO capability indication in a PHY service data unit (PSDU) encapsulated within the initial PPDU. More particularly, the initiator such as the non-AP STA device 120 can specify the DSO-related information in a new-type of trigger frame or a new field in the trigger frame, for soliciting at least one channel such as a certain non-20 MHz channel among the multiple non-20 MHz channels via the DSO-related information, and the responder such as the AP device 110 can reply the whole or a part of the solicited channel (e.g., the whole of the non-20 MHz channel or at least one 20 MHz channel within the non-20 MHz channel) according to its available information, but the present invention is not limited thereto. The initiator such as the non-AP STA device 120 can also specify the DSO-related information in the service field, For example, the non-AP STA device 120 can use extra 1 bit in the service field to represent its BW320-1 or BW320-2 for using the BW320-1 channel or the BW320-2 channel as the solicited channel. In some examples, the non-AP STA device 120 can use Bit 8 in the service field to represent the BW320-1 or BE320-2 for using the BW320-1 channel or the BW320-2 channel as the solicited channel.

As shown in FIG. 8, the non-AP STA device 120 and the AP device 110 can negotiate the access channel by using the initial PPDU and the response of the initial PPDU in multiple iterations. For example, in a first iteration, the non-AP STA device 120 can use the initial PPDU 810 to specify the first non-20 MHz channel such as the BW320-1 channel as the solicited channel of the first iteration, and the AP device 110 can use the response 811 of the initial PPDU 810, such as the response 811 on the whole of the BW320-1 channel, for granting using the whole of the BW320-1 channel as the solicited channel of the first iteration, to allow the non-AP STA device 120 and the AP device 110 to perform the data transmission within the transmission opportunity (TXOP) 812 on the BW320-1 channel; in a second iteration, the non-AP STA device 120 can use the initial PPDU 820 to specify the second non-20 MHz channel such as the BW320-2 channel as the solicited channel of the second iteration, and the AP device 110 can use the response 821 of the initial PPDU 820, such as the response 821 on the whole of the BW320-2 channel, for granting using the whole of the BW320-2 channel as the solicited channel of the second iteration, to allow the non-AP STA device 120 and the AP device 110 to perform the data transmission within the TXOP 822 on the BW320-2 channel; in a third iteration, the non-AP STA device 120 can use the initial PPDU 830 to specify the third non-20 MHz channel such as the BW320-1 channel as the solicited channel of the third iteration, and the AP device 110 can use the response 831 of the initial PPDU 830, such as the response 831 on a partial channel (e.g., a BW160 channel) of the BW320-1 channel, for granting using the partial channel such as the BW160 channel as a replacement of the solicited channel of the third iteration, to allow the non-AP STA device 120 and the AP device 110 to perform the data transmission within the TXOP 833 on the partial channel such as the BW160 channel, without using the remaining BW160 channel on the remaining BW160; and the rest can be deduced by analogy.

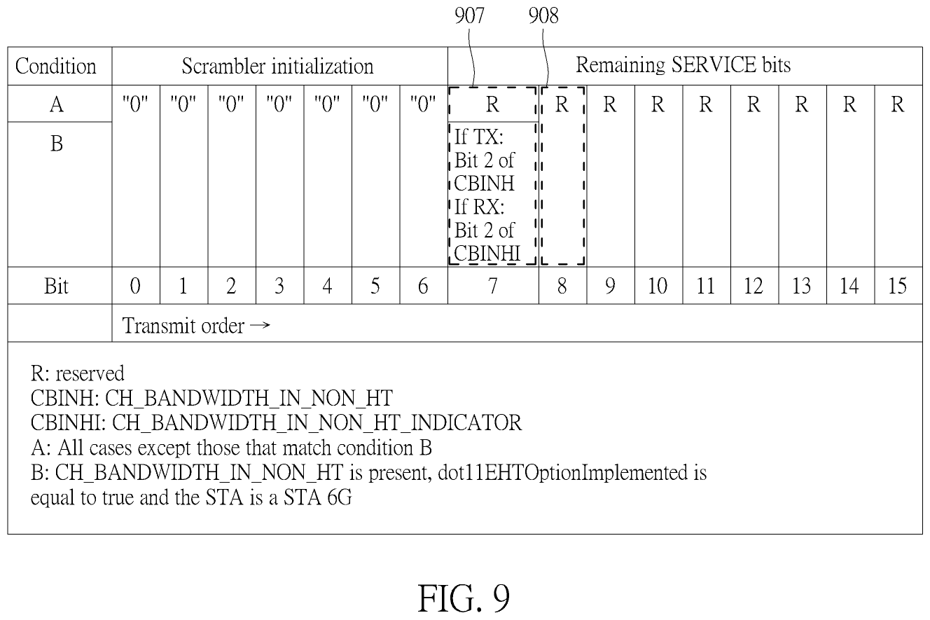

FIG. 9 illustrates a Service field format involved with the inter-PPDU handshaking control scheme shown in FIG. 8 according to an embodiment of the present invention. The Service field format may comprise the Scrambler initialization bits (e.g., “0”) regarding Scrambler initialization and the Remaining SERVICE bits along the Transmit order {0, 1, . . . , 15} as shown in FIG. 9, where “R” may stand for reserved for indicating the reserved bits, “CBINH” may stand for CH_BANDWIDTH_IN_NON_HT (or Channel-bandwidth-in-non-HT), and “CBINHI” may stand for CH_BANDWIDTH_IN_NON_HT_INDICATOR (or Channel-bandwidth-in-non-HT-indicator). The condition A may represent all cases except those that match the condition B. In addition, the condition B may represent the case that CH_BANDWIDTH_IN_NON_HT is present, dot11EHTOptionImplemented is equal to true and the STA is a STA 6G. As the beginning bit 907 among the Remaining SERVICE bits may be used in the condition B, the non-AP STA device 120 may use the extra 1 bit in the service field, such as any other bit among the Remaining SERVICE bits, to represent the BW320-1 or BW320-2 for using the BW320-1 channel or the BW320-2 channel as the solicited channel. For example, the non-AP STA device 120 may use Bit 8 in the service field, such as the next bit 908 of the beginning bit 907, to represent the BW320-1 or BE320-2 for using the BW320-1 channel or the BW320-2 channel as the solicited channel.

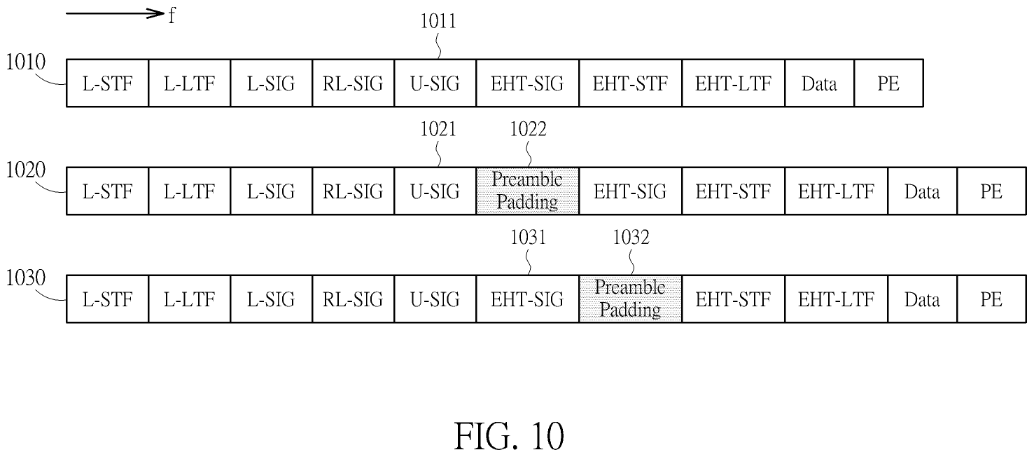

FIG. 10 illustrates an intra-PPDU signaling control scheme of the method according to an embodiment of the present invention. After getting a channel access opportunity, the non-AP STA device 120 may carry at least one DSO capability indication in a predetermined field of a PHY preamble within a first PPDU from the non-AP STA device 120 to the AP device 110, for indicating at least one DSO capability of the non-AP STA device 120, and one or more access channels may be configured with intra-PPDU signaling using the first PPDU, where the first non-20 MHz channel may be implemented as the one or more access channels. For example, the non-AP STA device 120 may insert padding within the first PPDU, posterior to the predetermined field, for a peer STA to switch to a target channel, where the peer STA may represent the AP device 110, and the target channel may represent the first non-20 MHz channel.

Based on the intra-PPDU signaling control scheme, the non-AP STA device 120 may get the channel access opportunity and specify the aforementioned at least one DSO capability indication such as the targeted access channel information (e.g., the DSO-related information indicating the targeted access channel) in the PHY preamble of the first PPDU (e.g., any PPDU among the PPDUs 1010, 1020 and 1030), and more particularly, specify the targeted access channel information in the predetermined field such as a predetermined SIG field within the PHY preamble, where the predetermined SIG field may represent the U-SIG field or the EHT-SIG field or any next-generation-SIG field. For example, the non-AP STA device 120 may specify the targeted access channel information in the U-SIG field 1011 within the PHY preamble of the PPDU 1010, but the present invention is not limited thereto. For another example, the non-AP STA device 120 may specify the targeted access channel information in the U-SIG field 1021 within the PHY preamble of the PPDU 1020, and insert the padding such as the preamble padding 1022 in the PPDU 1020, right after the U-SIG field 1021, to make a delay time corresponding to the preamble padding 1022 be a waiting time for the AP device 110 to prepare for switching to the targeted access channel (or the target channel) determined by the non-AP STA device 120. For yet another example, the non-AP STA device 120 may specify the targeted access channel information in the EHT-SIG field 1031 within the PHY preamble of the PPDU 1030, and insert the padding such as the preamble padding 1032 in the PPDU 1030, right after the EHT-SIG field 1031, to make a delay time corresponding to the preamble padding 1032 be a waiting time for the AP device 110 to prepare for switching to the targeted access channel (or the target channel) determined by the non-AP STA device 120. In some examples, the non-AP STA device 120 may insert the padding such as the preamble padding in any part among multiple different parts within the PPDU, for example, immediately coming after any field among the U-SIG field, the EHT-SIG field, the EHT-STF field, the EHT-LTF field, etc. Additionally, the capability field may be arranged to define the length of the preamble padding, the time corresponding to the preamble padding, and/or the switch time such as the channel switching time of the AP device 110 in different conditions.

According to some embodiments, the AP device 110 and the non-AP STA device 120 may be arranged to perform cooperative super-band operation (CSO) with aid of CCA information sharing, for enhancing overall performance of the wireless communication system 100. The CSO may comprise a cooperative channel access technology by decoupling the channel access bandwidth and the transceiver bandwidth, and may be applied to various channel access such as AP-AP channel access regarding Cooperative Multi-AP (MAP) (or the “C-MAP”), AP-STA channel access regarding out-of-band Data Datagram Transport Layer Security (TDLS), STA-AP channel access regarding reverse CSO/DSO, STA-STA channel access, etc. For better comprehension, the AP device 110 may be referred to as the first AP device 110, and another AP device among the multiple AP devices {110} may be referred to as the second AP device 110′. In addition, another non-AP STA device among the multiple non-AP STA devices {120} may be referred to as the other non-AP STA device 120′.

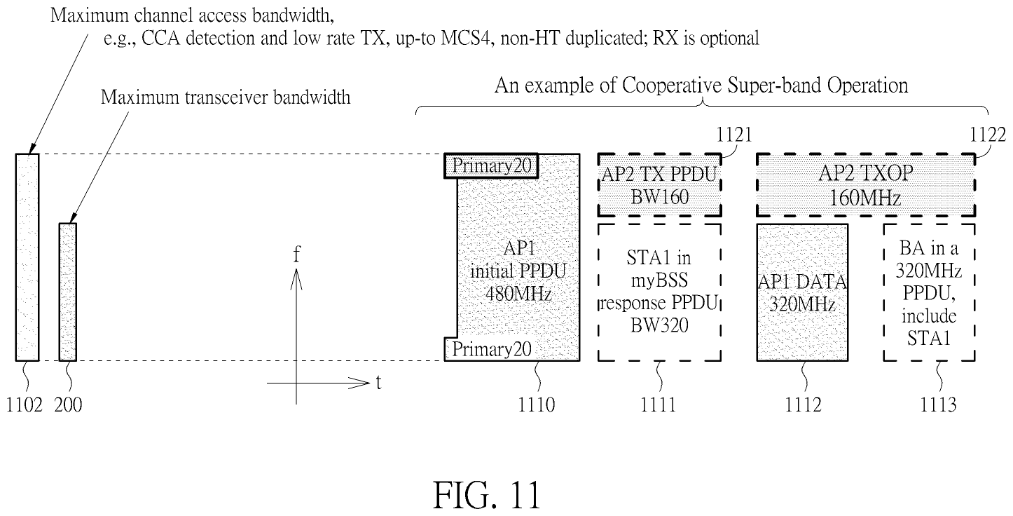

FIG. 11 illustrates a first CSO control scheme of the method according to an embodiment of the present invention. The first AP device 110 (e.g., the AP device AP1) may be arranged to detect a CCA status in a wider bandwidth 1102 that is wider than the maximum transceiver bandwidth 200 of the non-AP STA device 120 (e.g., the non-AP STA device STA1), and share CCA information indicating the CCA status to the second AP device 110′ (e.g., the AP device AP2), to make further data transmission between the first AP device 110 and the non-AP STA device 120 be performed on the first non-20 MHz channel and other data transmission between the second AP device 110′ and the other non-AP STA device 120′ be performed on another channel at a same time. In addition, the first AP device 110 (e.g., the AP device AP1) may be arranged to occupy the first non-20 MHz channel and the other channel, and prevent the aforementioned at least one OBSS from using the first non-20 MHz channel and the other channel until the first AP device 110 releases the first non-20 MHz channel and the other channel.

Based on the first CSO control scheme, the wider bandwidth 1102 may comprise the maximum channel access bandwidth regarding the CCA detection and the low rate transmission (TX), up-to Modulation and Coding Scheme 4 (MCS4), non-High Throughput (non-HT) duplicated (where reception (RX) is optional). As shown in FIG. 11, the wider bandwidth 1102 may be the 480 MHz bandwidth (BW480) corresponding to the BW320-1 channel and the BW320-2 channel (e.g., the BW320-1 channel 610 and the BW320-2 channel 620 that overlap each other as shown in FIG. 6). During the CSO, the first AP device 110 such as the AP device AP1 may send the initial PPDU 1110 on the BW480 to occupy the first non-20 MHz channel such as a certain BW320 channel (e.g., the BW320-1 channel) on a partial bandwidth of the BW480 and the other channel such as the BW160 channel on the remaining BW160 for reserving all channels on the BW480 first. The non-AP STA device 120 such as the non-AP STA device STA1 in its own BSS (or “the myBSS”) may send the response PPDU 1111 on the BW320, and the AP device AP1 may send data 1112 on the same BW320 channel, where the block acknowledgment (BA) 1113 may be sent in a 320 MHz PPDU on the same BW320 channel. For example, the primary channel within the BW320 channel may be a BW20 channel (labeled “Primary20” for brevity) on a first side (e.g., the lower side) of the whole BW480. In addition, the second AP device 110′ such as the AP device AP2 may start transmission (TX) with its own PPDU 1121 on the BW160 channel, and communicate with the other non-AP STA device 120′ within the TXOP 1122 on the same BW160 channel. For example, the primary channel within the BW160 channel may be a BW20 channel (labeled “Primary20” for brevity) on a second side (e.g., the upper side) of the whole BW480.

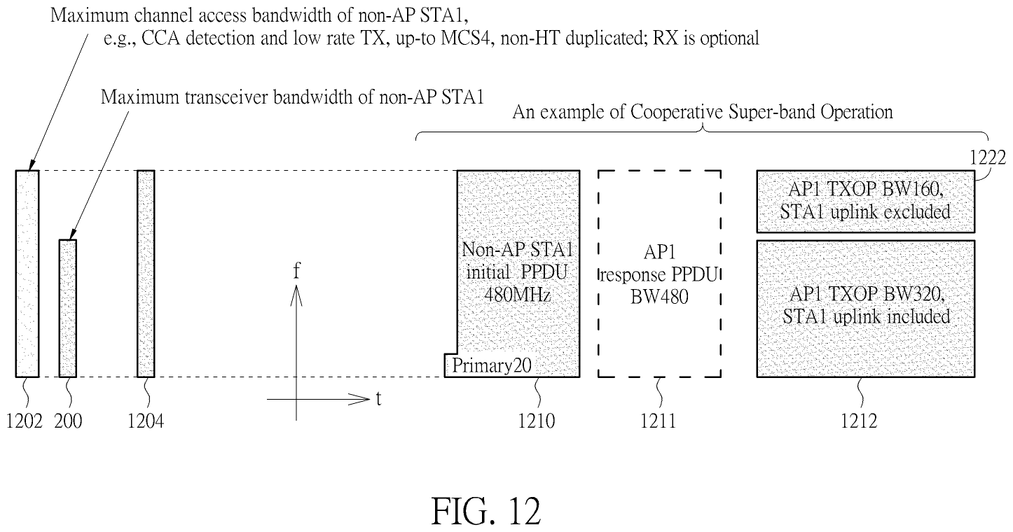

FIG. 12 illustrates a second CSO control scheme of the method according to an embodiment of the present invention. The non-AP STA device 120 (e.g., the non-AP STA device STA1) may be arranged to detect a CCA status in a wider bandwidth 1202 that is wider than the maximum transceiver bandwidth 200 of the non-AP STA device 120, and carry at least one DSO capability indication in an initial PPDU from the non-AP STA device 120 to the first AP device 110 (e.g., the AP device AP1), for occupying the first non-20 MHz channel and another channel for the first AP device 110, in order to enhance at least one of spectrum efficiency and system efficiency of the first AP device 110, where the wider bandwidth 1202 may represent the maximum CCA bandwidth 202. In addition, the first AP device 110 (e.g., the AP device AP1) may be arranged to make further data transmission between the first AP device 110 and the non-AP STA device 120 be performed on the first non-20 MHz channel and other data transmission between the first AP device 110 and the non-AP STA device 120 be performed on the other channel at a same time. More particularly, the non-AP STA 120 (e.g., the non-AP STA device STA1) may be arranged to occupy the first non-20 MHz channel and the other channel for the first AP device 110 by sending the initial PPDU from the non-AP STA device 120 to the first AP device 110, to allow the first AP device 110 to continue occupying the first non-20 MHz channel and the other channel, in order to prevent the aforementioned at least one OBSS from using the first non-20 MHz channel and the other channel until the first AP device 110 releases the first non-20 MHz channel and the other channel.

Based on the second CSO control scheme, the wider bandwidth 1202 may comprise the maximum channel access bandwidth of the non-AP STA device STA1 regarding the CCA detection and the low rate TX, up-to MCS4, non-HT duplicated (where RX is optional). As shown in FIG. 12, the wider bandwidth 1202 may be the 480 MHz bandwidth (BW480) corresponding to the BW320-1 channel and the BW320-2 channel (e.g., the BW320-1 channel 610 and the BW320-2 channel 620 that overlap each other as shown in FIG. 6). During the CSO, the non-AP STA device 120 such as the non-AP STA device STA1 may send the initial PPDU 1210 on the BW480 to occupy the first non-20 MHz channel such as a certain BW320 channel (e.g., the BW320-1 channel) on a partial bandwidth of the BW480 and the other channel such as the BW160 channel on the remaining BW160 for reserving all channels on the BW480 first, and the first AP device 110 such as the AP device AP1 may send the response PPDU 1211 on the BW480 to continue occupying the BW320 channel (e.g., the BW320-1 channel) and the BW160 channel for continuing reserving all channels on the BW480, and communicate with the non-AP STA device STA1 within the TXOP 1212 on the BW320 channel, with the uplink of the non-AP STA device STA1 being included. For example, the primary channel within the BW320 channel on the partial bandwidth of the BW480 may be a BW20 channel (labeled “Primary20” for brevity) on a first side (e.g., the lower side) of the whole BW480. In addition, the AP device AP1 may communicate with the other non-AP STA device 120′ within the TXOP 1222 on the BW160 channel, with the uplink of the non-AP STA device STA1 being excluded.

For example, the non-AP STA device STA1 can perform the CSO with the associated AP device AP1 to enhance the spectrum efficiency, the system efficiency, etc. of the AP device AP1, and the non-AP STA device STA1 can access the wider bandwidth 1202 that is wider than its maximum transceiver bandwidth 200 and share it to the AP device AP1 for better system efficiency and better spectrum efficiency. As the AP device AP1 can also access a wider bandwidth 1204 (e.g., the maximum channel access bandwidth of the AP device AP1) that is wider than the maximum transceiver bandwidth 200, the AP device AP1 can perform the CSO fluently with the aid of the non-AP STA device STA1.

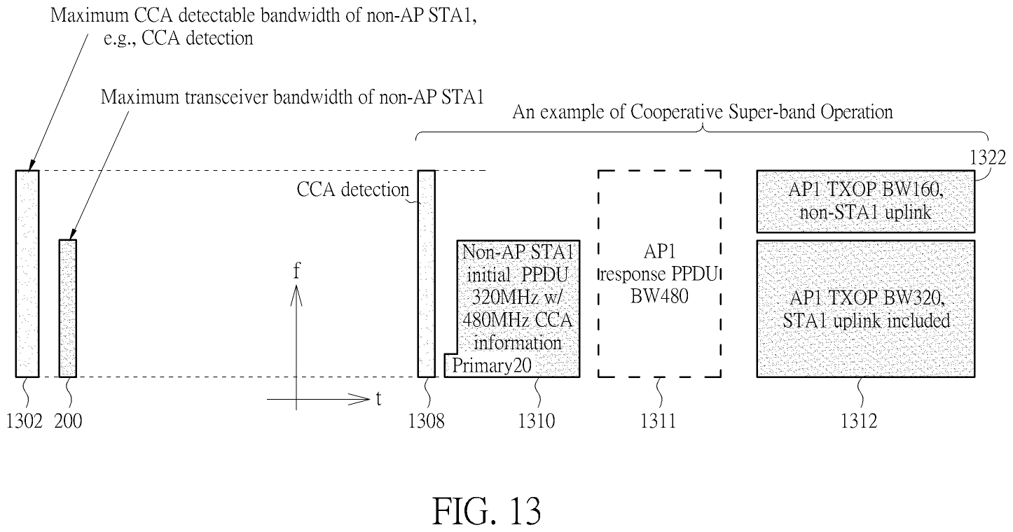

FIG. 13 illustrates a third CSO control scheme of the method according to an embodiment of the present invention. The non-AP STA device 120 (e.g., the non-AP STA device STA1) may be arranged to detect a CCA status in a wider bandwidth 1302 that is wider than the maximum transceiver bandwidth 200 of the non-AP STA device 120, carry at least one DSO capability indication in an initial PPDU from the non-AP STA device 120 to the first AP device 110 (e.g., the AP device AP1), for occupying the first non-20 MHz channel, and share CCA information indicating the CCA status to the first AP device 110 via the initial PPDU, in order to enhance at least one of spectrum efficiency and system efficiency of the first AP device 110, where the wider bandwidth 1302 may represent the maximum CCA bandwidth 202. In addition, the first AP device 110 (e.g., the AP device AP1) may be arranged to enlarge a channel access bandwidth for transmission of the first AP device 110 based on the CCA information of the non-AP STA device 120 (e.g., the non-AP STA device STA1), to make further data transmission between the first AP device 110 and the non-AP STA device 120 be performed on the first non-20 MHz channel and other data transmission between the first AP device 110 and the other non-AP STA device 120′ be performed on another channel at a same time. More particularly, the non-AP STA 120 (e.g., the non-AP STA device STA1) may be arranged to occupy the first non-20 MHz channel for the first AP device 110 (e.g., the AP device AP1) and share the CCA information to the first AP device 110 by sending the initial PPDU from the non-AP STA device 120 to the first AP device 110, to allow the first AP device 110 to occupy both of the first non-20 MHz channel and the other channel, in order to prevent the aforementioned at least one OBSS from using the first non-20 MHz channel and the other channel until the first AP device 110 releases the first non-20 MHz channel and the other channel.

Based on the third CSO control scheme, the wider bandwidth 1302 may comprise the maximum CCA detectable bandwidth of the non-AP STA device STA1 regarding the CCA detection. As shown in FIG. 13, the wider bandwidth 1302 may be the 480 MHz bandwidth (BW480) corresponding to the BW320-1 channel and the BW320-2 channel (e.g., the BW320-1 channel 610 and the BW320-2 channel 620 that overlap each other as shown in FIG. 6). During the CSO, the non-AP STA device 120 such as the non-AP STA device STA1 may perform the CCA detection 1308 first, and send the initial PPDU 1310 carrying the CCA information (e.g., the 480 MHz CCA information) on a certain 320 MHz bandwidth (BW320) such as one of the BW320-1 and the BW320-2 within the BW480, in order to occupy the first non-20 MHz channel such as a corresponding BW320 channel (e.g., the BW320-1 channel) on the BW320 and share the CCA information, and the first AP device 110 such as the AP device AP1 may send the response PPDU 1311 on the BW480 to occupy the corresponding BW320 channel (e.g., the BW320-1 channel) and the BW160 channel on the remaining BW160 for reserving all channels on the BW480, and communicate with the non-AP STA device STA1 within the TXOP 1312 on the BW320 channel, with the uplink of the non-AP STA device STA1 being included. For example, the primary channel within the corresponding BW320 channel on the BW320 may be a BW20 channel (labeled “Primary20” for brevity) on a first side (e.g., the lower side) of the whole BW320. In addition, the AP device AP1 may communicate with the other non-AP STA device 120′ (e.g., a certain non-AP STA device that differs from the non-AP STA device STA1, or “the non-STA1”) within the TXOP 1322 on the BW160 channel, with the uplink of the other non-AP STA device 120′ being included.

For example, the non-AP STA device STA1 can perform the CSO together with the associated AP device AP1 to enhance the spectrum efficiency and the system efficiency of the AP device AP1. More particularly, the non-AP STA device STA1 can detect the CCA status in the wider bandwidth 1302 that is wider than its maximum transceiver bandwidth 200 and share the CCA information to the AP device AP1 for better system efficiency and better spectrum efficiency, and the AP device AP1 can enlarge the channel access bandwidth on its transmission based on the CCA information of the non-AP STA device STA1.

According to some embodiments, the non-AP STA device 120 and the AP device 110 may communicate with each other using at least one CSO protocol, and more particularly, may perform CSO handshaking in multiple ways (e.g., inter-PPDU handshaking, intra-PPDU signaling, and a new type of trigger frame from the non-AP side) for using the targeted access channel(s) and/or occupying at least one portion of channels (e.g., a portion of channels or all channels) within any predetermined RF band among the multiple predetermined RF bands. For example, the TXOP initiator such as the non-AP STA device 120 may be able to access a partial bandwidth within the BW480 rather than the whole BW480, and may be arranged to only bring the CCA information to the peer STA such as the AP device 110. Regarding sharing the super-band CCA information, the TXOP initiator such as the non-AP STA device 120 can put the extra CCA idle information (e.g., the extra CCA idle 20 MHz bitmap or extra CCA-idle BW) in the service field for a legacy frame. Taking the Service field format shown in FIG. 9 as an example, the TXOP initiator such as the non-AP STA device 120 can use the Bits 8-15 in the service field to provide the CCA information for the CCA detectable BW. In addition, one or more extra fields in the current trigger frame may be used for indicating the whole BW CCA status, but the present invention is not limited thereto. In some examples, any new type of trigger frame from the non-AP side (or the non-AP STA device 120) may be used for indicating the whole BW CCA status, and/or some of the fields shall be redefined or be removed from the current trigger frame.

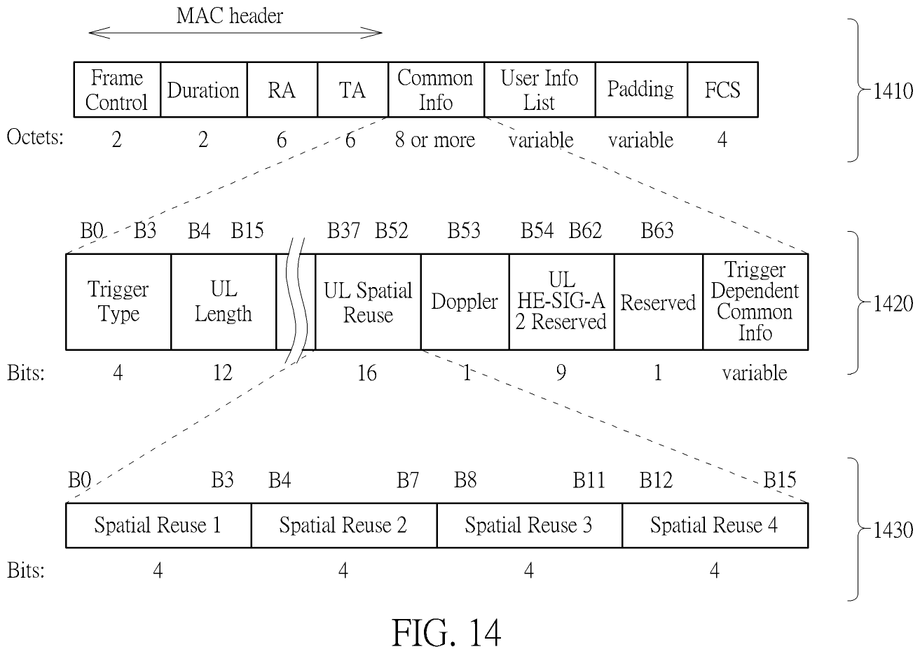

FIG. 14 illustrates a Trigger frame format 1410, a Common Info (or Information) field format 1420 and an UL (or Uplink) Spatial Reuse subfield format 1430 involved with a CCA information control scheme of the method according to an embodiment of the present invention. The Trigger frame format 1410 may comprise a Frame Control field, a Duration field, a Receiver Address (RA) field and a Transmitter Address (TA) field within the Medium Access Control (MAC) header, and further comprise a Common Info field, a User Info List field, a Padding field and a FCS field, where these fields may have their own lengths measured in unit of octets (or bytes). The Common Info field may comprise multiple subfields such as the Trigger Type subfield at the bits B0-B3, the UL Length subfield at the bits B4-B15, etc., as well as the UL Spatial Reuse subfield at the bits B37-B52, the Doppler subfield at the bit B53, the UL HE-SIG-A2 Reserved subfield at the bits B54-B62, the Reserved subfield at the bit B63 and the Trigger Dependent Common Info subfield. The UL Spatial Reuse subfield may comprise multiple subfields such as the Spatial Reuse 1 subfield at the bits B0-B3, the Spatial Reuse 2 subfield at the bits B4-B7, the Spatial Reuse 3 subfield at the bits B8-B11, and the Spatial Reuse 4 subfield at the bits B12-B15.

Based on the CCA information control scheme, the TXOP initiator such as the non-AP STA device 120 can use the one or more extra fields in the current trigger frame to indicate the whole BW CCA status. This can be achieved by redefining the UL Spatial Reuse subfield and/or the HE-SIG-A reserved subfield, for being used as the one or more extra fields, where the reserved bit at the bit B63 can be arranged to indicate the CCA status and/or indicate whether the CCA information for indicating the whole BW CCA status exists in the one or more extra fields. For example, the TXOP initiator such as the non-AP STA device 120 can use the bit B63 to redefine the Spatial Reuse subfield as CCA information. Besides, the TXOP initiator such as the non-AP STA device 120 can use 1 bit in the UL HE-SIG-A 2 Reserved field (e.g., the bit B62 of the Common Info field format 1420) as the CCA status resolution. For example, the non-AP STA device 120 can use the bit B62 to indicate the resolution of 20 MHz CCA status or 40 MHz CCA status for 1 bit in the CCA bitmap. If the bit B62 is equal to a first predetermined logic value, any bit of the bits in the CCA bitmap may represent the CCA status of a corresponding BW20, such as the status of whether the corresponding BW20 is clear (or non-occupied) for being used; otherwise, when the bit B62 is equal to a second predetermined logic value, any bit of the bits in the CCA bitmap may represent the CCA status of a corresponding BW40, such as the status of whether the corresponding BW40 is clear (or non-occupied) for being used. For example, the first predetermined logic value may represent the logic value 0, and the second predetermined logic value may represent the logic value 1. For another example, the first predetermined logic value may represent the logic value 1, and the second predetermined logic value may represent the logic value 0. In some examples, more predetermined bits in the one or more extra fields may be arranged to indicate more CCA status resolutions such as the resolutions of 20 MHz CCA status, 40 MHz CCA status, 80 MHz CCA status, etc. for 1 bit in the CCA bitmap.

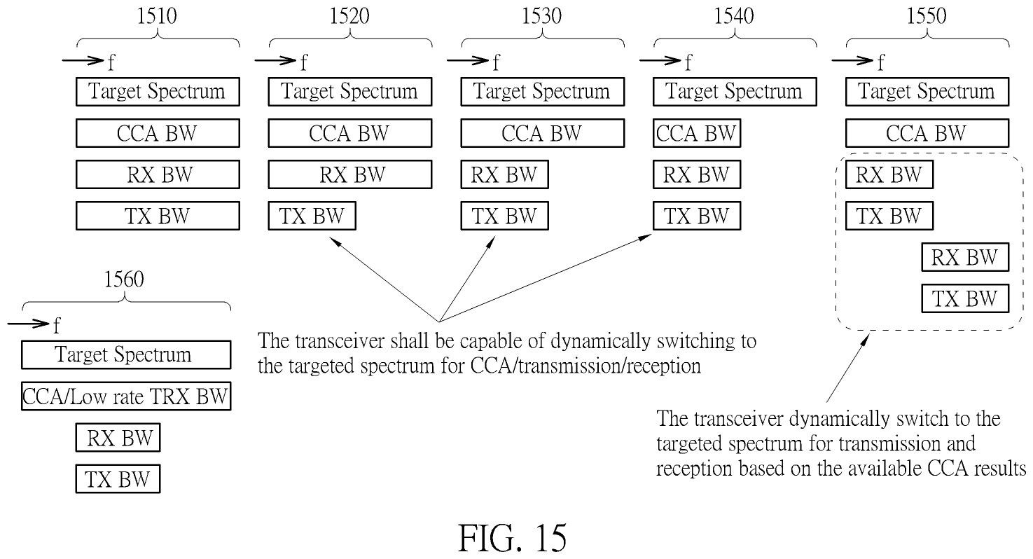

FIG. 15 illustrates a plurality of transceiver bandwidth (BW) designs 1510, 1520, 1530, 1540, 1550 and 1560 involved with a DSA control scheme of the method according to an embodiment of the present invention. In comparison with the related art architecture, the architecture having the CCA bandwidth capability that is often the same as the transmission (TX) bandwidth capability and the reception (RX) bandwidth capability, the new transceiver architectures of various transceiver BW designs (e.g., the transceiver BW designs 1510, 1520, 1530, 1540, 1550 and 1560) in the DSA control scheme can be arranged to support dynamic spectrum access (DSA). For example, the new transceiver architectures of the transceiver BW designs 1510, 1520, 1530, 1540, 1550 and 1560 may be adopted architecture according to different considerations such as that of capability mismatch, transceiver cost, etc., respectively. As shown in FIG. 15, the target spectrums of the transceiver BW designs 1510, 1520, 1530, 1540, 1550 and 1560 may be equal to each other, but the designed BWs such as the CCA BWs, the RX BW, the TX BW and/or the low rate transceiver (TRX) BW may vary with respect to the designs. Regarding the transceiver BW designs 1520, 1530 and 1540, the transceiver shall be capable of dynamically switching to the targeted spectrum for any operation among the operations of CCA, transmission and reception. Regarding the transceiver BW design 1550, the transceiver can dynamically switch to the targeted spectrum for transmission and reception based on the available CCA results.

Regard the architecture design of the non-AP STA device 120, at least one portion of transceiver BW designs (e.g., a portion of transceiver BW designs or all transceiver BW designs) among the transceiver BW designs 1510, 1520, 1530, 1540, 1550 and 1560 can be applied to the communication control circuit 124 (or any transceiver therein) of the non-AP STA device 120 to expanded the CCA bandwidth of the communication control circuit 124. For example, the non-AP STA device 120 can perform CCA-related detection (e.g., carrier sense and energy detection) on the expanded CCA bandwidth. As a result, during the DSO, the non-AP STA device 120 can configure the CCA detectable channels corresponding to the expanded CCA bandwidth, in order to enhance the overall performance. In addition, during the CSO, the non-AP STA device 120 can occupy more channels corresponding to the expanded CCA bandwidth for the AP device 110 or help the AP device 110 to occupy more channels corresponding to the expanded CCA bandwidth, in order to enhance the overall performance.

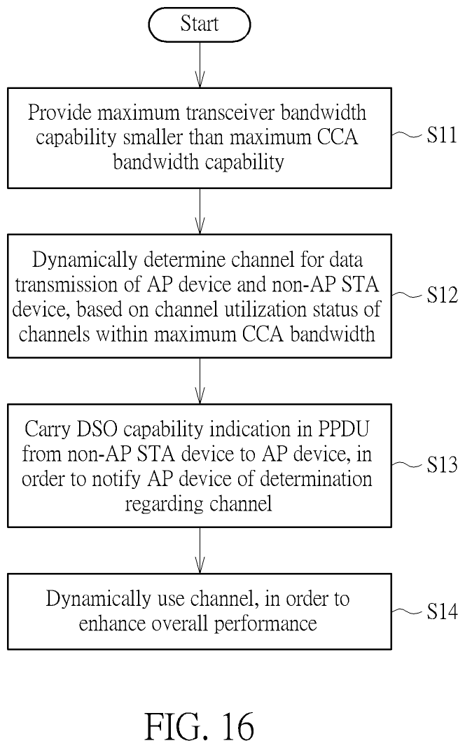

FIG. 16 illustrates a working flow of the method according to an embodiment of the present invention. For example, the aforementioned any wireless transceiver device #n such as the AP device 110 can be implemented as the AP MLD, and the other wireless transceiver device #n′ such as the non-AP STA device 120 can be implemented as the non-AP MLD, but the present invention is not limited thereto. In addition, a plurality of non-AP STA devices such as the multiple non-AP STA devices {120} mentioned above may be wirelessly linking to the AP device 110 having a maximum CCA bandwidth capability corresponding to a maximum CCA bandwidth, where the multiple non-AP STAs {120} are able to link to the AP device 110 via a plurality of channels (e.g., the multiple non-20 MHz channels) within the maximum CCA bandwidth, respectively.

In Step S11, at least one of the multiple non-AP STA devices {120}, such as the non-AP STA device 120 (or the communication control circuit 124 therein), may provide a maximum transceiver bandwidth capability for the aforementioned at least one of the multiple non-AP STA devices {120} smaller than the maximum CCA bandwidth capability of the AP device 110.

In Step S12, the aforementioned at least one of the multiple non-AP STA devices {120}, such as the non-AP STA device 120 (or the communication control circuit 124 therein), may dynamically determine a first channel among the plurality of channels, such as the first non-20 MHz channel among the multiple non-20 MHz channels (e.g., the multiple BW320 channels), for the data transmission of the AP device 110 and the aforementioned at least one (e.g., the non-AP STA device 120) of the multiple non-AP STA devices {120}, based on channel utilization status of the plurality of channels within the maximum CCA bandwidth.

In Step S13, the aforementioned at least one of the multiple non-AP STA devices {120}, such as the non-AP STA device 120 (or the communication control circuit 124 therein), may carry the aforementioned at least one DSO capability indication in the aforementioned at least one PPDU from the aforementioned at least one (e.g., the non-AP STA device 120) of the multiple non-AP STA devices {120} to the AP device 110, in order to notify the AP device 110 of the determination regarding the first channel such as the first non-20 MHz channel.

In Step S14, the AP device 110 (or the communication control circuit 114 therein) may dynamically use the first channel such as the first non-20 MHz channel during the data transmission of the AP device 110 and the aforementioned at least one (e.g., the non-AP STA device 120) of the multiple non-AP STA devices {120}, in order to enhance the overall performance (e.g., spectrum efficiency and system efficiency) of the wireless communication system 100.

For better comprehension, the method may be illustrated with the working flow shown in FIG. 11, but the present invention is not limited thereto. According to some embodiments, one or more steps may be added, deleted, or changed in the working flow shown in FIG. 11. For example, the operations of Steps S12-S14 may be performed in multiple iterations, and therefore after the execution of Step S14, a partial working flow indicating the multiple iterations may be illustrated with an arrow pointing to Step S12 from Step S14. More particularly, in Step S12, the non-AP STA device 120 (or the communication control circuit 124) may dynamically determine another channel among the plurality of channels, such as another non-20 MHz channel among the multiple non-20 MHz channels (e.g., the multiple BW320 channels), for the data transmission of the AP device 110 and the aforementioned at least one (e.g., the non-AP STA device 120) of the multiple non-AP STA devices {120}, based on the latest channel utilization status of the plurality of channels within the maximum CCA bandwidth; in Step S13, the aforementioned at least one of the multiple non-AP STA devices {120}, such as the non-AP STA device 120 (or the communication control circuit 124), may carry at least one other DSO capability indication in at least one other PPDU from the aforementioned at least one (e.g., the non-AP STA device 120) of the multiple non-AP STA devices {120} to the AP device 110, in order to notify the AP device 110 of the determination regarding the other channel such as the other non-20 MHz channel; and in Step S14, the AP device 110 (or the communication control circuit 114) may dynamically use the other channel such as the other non-20 MHz channel during the data transmission of the AP device 110 and the aforementioned at least one (e.g., the non-AP STA device 120) of the multiple non-AP STA devices {120}. For brevity, similar descriptions for these embodiments are not repeated in detail here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing dynamic super-band operation (DSO) in a wireless communication system, wherein a plurality of non-access-point stations (non-AP STAs) are wirelessly linking to a first access point (AP) having a maximum clear channel assessment (CCA) bandwidth capability corresponding to a maximum CCA bandwidth, the non-AP STAs being able to link to the first AP via a plurality of channels within the maximum CCA bandwidth, respectively, the method comprising:
providing a maximum transceiver bandwidth capability for at least one of the non-AP STAs smaller than the maximum CCA bandwidth capability of the first AP; and
dynamically determining a first channel among the plurality of channels for data transmission of the first AP and the at least one of the non-AP STAs, based on channel utilization status of the plurality of channels within the maximum CCA bandwidth.

2. The method of claim 1, wherein at least one portion of channels among the plurality of channels overlap each other, and the first channel is a channel among the at least one portion of channels.

3. The method of claim 1, wherein dynamically determining the first channel among the plurality of channels for the data transmission of the first AP and the at least one of the non-AP STAs based on channel utilization status of the plurality of channels within the maximum CCA bandwidth further comprises:
dynamically determining the first channel among the plurality of channels for the data transmission of the first AP and the at least one of the non-AP STAs, in order to prevent using at least one first overlapping-basic-service-set-occupied (OBSS-occupied) channel of at least one overlapping basic service set (OBSS) during the data transmission of the first AP and the at least one of the non-AP STAs; and
dynamically determining a second channel among the plurality of channels for the data transmission of the first AP and the at least one of the non-AP STAs, in order to prevent using at least one second OBSS-occupied channel of the at least one OBSS during the data transmission of the first AP and the at least one of the non-AP STAs.

4. The method of claim 3, wherein the first channel is determined to exclude the at least one first OBSS-occupied channel, for using the first channel corresponding to the maximum transceiver bandwidth while preventing interference from a first OBSS among the at least one OBSS; and the second channel is determined to exclude the at least one second OBSS-occupied channel, for using the second channel corresponding to the maximum transceiver bandwidth while preventing interference from a second OBSS among the at least one OBSS.

5. The method of claim 3, wherein the first channel is determined to exclude the at least one first OBSS-occupied channel, for using the first channel corresponding to the maximum transceiver bandwidth while preventing interference from a first OBSS among the at least one OBSS; and the second channel is determined to exclude the at least one second OBSS-occupied channel, for using the second channel corresponding to the maximum transceiver bandwidth while preventing interference from the first OBSS.

6. The method of claim 1, wherein the first channel is determined to exclude at least one first overlapping-basic-service-set-occupied (OBSS-occupied) channel, for using the first non-20 MHz channel corresponding to the maximum transceiver bandwidth while preventing interference from a first overlapping basic service set (OBSS) among at least one OBSS.

7. The method of claim 1, wherein at a first time point of determining the first channel for the data transmission of the first AP and the at least one of the non-AP STAs, at least one overlapping basic service set (OBSS) has occupied at least one portion of a negotiated maximum bandwidth of the at least one of the non-AP STAs; and the first channel is determined to be partially outside the negotiated maximum bandwidth.

8. The method of claim 7, wherein at a second time point of determining another channel for the data transmission of the first AP and the at least one of the non-AP STAs, the at least one OBSS has occupied at least one other portion of the negotiated maximum bandwidth of the at least one of the non-AP STAs; and the other channel is determined to be partially outside the negotiated maximum bandwidth.

9. The method of claim 8, wherein a first bandwidth of the first channel is equal to the negotiated maximum bandwidth, and a second bandwidth of the other channel is less than the negotiated maximum bandwidth.

10. The method of claim 7, wherein a first bandwidth of the first channel is equal to the negotiated maximum bandwidth.

11. The method of claim 7, wherein the negotiated maximum bandwidth is less than or equal to the maximum transceiver bandwidth.

12. The method of claim 1, wherein by dynamically determining at least the first channel for the data transmission of the first AP and the at least one of the non-AP STAs, the data transmission is performed without degradation of media access efficiency.

13. The method of claim 1, wherein the first channel comprises a set of first sub-channels corresponding to the maximum transceiver bandwidth, and a second channel among the plurality of channels that is determined for performing the data transmission of the first AP and the at least one of the non-AP STAs comprises a set of second sub-channels corresponding to the maximum transceiver bandwidth; and a second primary channel in the set of second sub-channels is equal to a first primary channel in the set of first sub-channels.

14. The method of claim 1, wherein the first AP is implemented as a first AP multi-link device (MLD), and the at least one of the non-AP STAs is implemented as a non-AP STA MLD; the first channel and a second channel among the plurality of channels that is determined for performing the data transmission of the first AP and the at least one of the non-AP STAs are configured as channels for multi-link operation (MLO); and the data transmission of the first AP and the at least one of the non-AP STAs comprises dynamically accessing between a first enhanced multi-link single radio (EMLSR) link at the first channel and a second EMLSR link at the second channel.

15. The method of claim 14, wherein a capability field in an enhanced multi-link (EML) element is arranged to specify that a first bandwidth used by the first EMLSR link and a second bandwidth used by the second EMLSR link are partially overlapping bandwidths of each other, wherein the capability field is arranged to carry a flag and at least one overlapping frequency among the first bandwidth used by the first EMLSR link and the second bandwidth used by the second EMLSR link.

16. The method of claim 1, wherein the first channel and a second channel among the plurality of channels that is determined for the data transmission of the first AP and the at least one of the non-AP STAs overlap each other; and the first channel and the second channel are configured as channels in a first predetermined radio frequency (RF) band among multiple predetermined RF bands.

17. The method of claim 1, wherein the at least one of the non-AP STAs is arranged to carry at least one DSO capability indication in a first communication frame from the at least one of the non-AP STAs to the first AP, for specifying at least one DSO capability of the at least one of the non-AP STAs, in order to dynamically switch among the multiple channels.

18. The method of claim 17, wherein the at least one of the non-AP STAs is arranged to use the at least one DSO capability indication to specify one or a combination of at least one operating bandwidth and at least one operating channel regarding the DSO.

19. The method of claim 1, wherein the at least one of the non-AP STAs is arranged to carry at least one DSO capability indication in an initial physical layer (PHY) protocol data unit (PPDU) from the at least one of the non-AP STAs to the first AP, for indicating at least one DSO capability of the at least one of the non-AP STAs; and one or more access channels are configured with inter-PPDU handshaking, wherein the inter-PPDU handshaking comprises negotiating by using the initial PPDU and a response of the initial PPDU that is sent from the first AP, and the first non-20 MHz channel is implemented as the one or more access channels.

20. The method of claim 19, wherein the initial PPDU is implemented by a per-20 megahertz (MHz) duplicated PPDU which is arranged to specify the at least one DSO capability indication in a PHY service data unit (PSDU) encapsulated within the initial PPDU.

21. The method of claim 1, wherein after getting a channel access opportunity, the at least one of the non-AP STAs is arranged to carry at least one DSO capability indication in a predetermined field of a physical layer (PHY) preamble within a first PHY protocol data unit (PPDU) from the at least one of the non-AP STAs to the first AP, for indicating at least one DSO capability of the at least one of the non-AP STAs; and one or more access channels are configured with intra-PPDU signaling using the first PPDU, wherein the first channel is implemented as the one or more access channels.

22. The method of claim 21, wherein the at least one of the non-AP STAs is arranged to insert padding within the first PPDU, posterior to the predetermined field, for a peer STA to switch to a target channel, wherein the peer STA represents the first AP, and the target channel represents the first channel.

23. The method of claim 1, wherein the first AP and the at least one of the non-AP STAs are arranged to perform cooperative super-band operation (CSO) with aid of CCA information sharing, for enhancing overall performance of the wireless communication system.

24. The method of claim 23, wherein the first AP is arranged to detect a CCA status in a wider bandwidth that is wider than the maximum transceiver bandwidth of the at least one of the non-AP STAs, and share CCA information indicating the CCA status to a second AP, to make further data transmission between the first AP and the at least one of the non-AP STAs be performed on the first channel and other data transmission between the second AP and another non-AP STA be performed on another channel at a same time; and the first AP is arranged to occupy the first channel and the other channel, and prevent at least one overlapping basic service set (OBSS) from using the first channel and the other channel until the first AP releases the first channel and the other channel.

25. The method of claim 23, wherein the non-AP STA is arranged to detect a CCA status in a wider bandwidth that is wider than the maximum transceiver bandwidth of the at least one of the non-AP STAs, and carry at least one DSO capability indication in an initial physical layer (PHY) protocol data unit (PPDU) from the at least one of the non-AP STAs to the first AP, for occupying the first channel and another channel for the first AP, in order to enhance at least one of spectrum efficiency and system efficiency of the first AP, wherein the wider bandwidth represents the maximum CCA bandwidth; the first AP is arranged to make further data transmission between the first AP and the at least one of the non-AP STAs be performed on the first channel and other data transmission of the first AP and the at least one of the non-AP STAs be performed on the other channel at a same time; and the at least one of the non-AP STAs is arranged to occupy the first channel and the other channel for the first AP by sending the initial PPDU from the at least one of the non-AP STAs to the first AP, to allow the first AP to continue occupying the first channel and the other channel, in order to prevent the at least one overlapping basic service set (OBSS) from using the first channel and the other channel until the first AP releases the first channel and the other channel.

26. The method of claim 23, wherein the at least one of the non-AP STAs is arranged to detect a CCA status in a wider bandwidth that is wider than the maximum transceiver bandwidth of the at least one of the non-AP STAs, carry at least one DSO capability indication in an initial physical layer (PHY) protocol data unit (PPDU) from the at least one of the non-AP STAs to the first AP, for occupying the first non-20 MHz channel, and share CCA information indicating the CCA status to the first AP via the initial PPDU, in order to enhance at least one of spectrum efficiency and system efficiency of the first AP, wherein the wider bandwidth represents the maximum CCA bandwidth; the first AP is arranged to enlarge a channel access bandwidth for transmission of the first AP based on the CCA information of the at least one of the non-AP STAs, to make further data transmission of the first AP and the at least one of the non-AP STAs be performed on the first channel and other data transmission of the first AP and another non-AP STA be performed on another channel at a same time; and the at least one of the non-AP STAs is arranged to occupy the first channel for the first AP and share the CCA information to the first AP by sending the initial PPDU from the at least one of the non-AP STAs to the first AP, to allow the first AP to occupy both of the first channel and the other channel, in order to prevent the at least one overlapping basic service set (OBSS) from using the first channel and the other channel until the first AP releases the first channel and the other channel.

27. A non-access-point station (non-AP STA) device, for performing dynamic super-band operation (DSO) in a wireless communication system, the non-AP STA device comprising:
a processing circuit, arranged to control operations of the non-AP STA device; and
at least one communication control circuit, coupled to the processing circuit, arranged to perform communication control, wherein the at least one communication control circuit is arranged to perform wireless communication operations with at least one other device within the wireless communication system for the non-AP STA device, wherein the at least one other device comprises a first access point (AP) device, and a plurality non-AP STA devices comprising the non-AP STA device are wirelessly linking to the first AP device having a maximum CCA bandwidth capability corresponding to a maximum CCA bandwidth, with the non-AP STA devices being able to link to the first AP device via a plurality of channels within the maximum CCA bandwidth, respectively;
wherein:
at least one of the non-AP STA devices, comprising the non-AP STA device, is arranged to provide a maximum transceiver bandwidth capability for the at least one of the non-AP STA devices smaller than the maximum CCA bandwidth capability of the AP device; and
the at least one of the non-AP STA devices, comprising the non-AP STA device, is arranged to dynamically determine a first channel among the plurality of channels for data transmission of the first AP device and the at least one of the non-AP STA devices, based on channel utilization status of the plurality of channels within the maximum CCA bandwidth.

28. The non-AP STA device of claim 27, wherein at least one portion of channels among the plurality of channels overlap each other, and the first channel is a channel among the at least one portion of channels.

29. An access point (AP) device, for performing dynamic super-band operation (DSO) in a wireless communication system, the AP device comprising:
a processing circuit, arranged to control operations of the AP device; and
at least one communication control circuit, coupled to the processing circuit, arranged to perform communication control, wherein the at least one communication control circuit is arranged to perform wireless communication operations with at least one other device within the wireless communication system for the AP device, wherein the at least one other device comprises a plurality of non-access-point station (non-AP STA) devices, and the plurality of non-AP STA devices are wirelessly linking to the AP device having a maximum CCA bandwidth capability corresponding to a maximum CCA bandwidth, with the non-AP STA devices being able to link to the AP device via a plurality of channels within the maximum CCA bandwidth, respectively;
wherein:
at least one of the non-AP STA devices is arranged to provide a maximum transceiver bandwidth capability for the at least one of the non-AP STA devices smaller than the maximum CCA bandwidth capability of the AP device;
the at least one of the non-AP STA devices is arranged to dynamically determine a first channel among the plurality of channels for data transmission of the AP device and the at least one of the non-AP STA devices, based on channel utilization status of the plurality of channels within the maximum CCA bandwidth; and
the at least one of the non-AP STA devices is arranged to carry at least one DSO capability indication in at least one physical layer (PHY) protocol data unit (PPDU) from the at least one of the non-AP STA device to the AP device, in order to notify the AP device of the determination regarding the first channel, and the AP device is arranged to dynamically use the first channel during the data transmission of the AP device and the at least one of the non-AP STA device.

30. The AP device of claim 29, wherein at least one portion of channels among the plurality of channels overlap each other, and the first channel is a channel among the at least one portion of channels.
